(19) United States
(12) Patent Application Publication
(10) Pub. No.: US 2008/0071544 A1
(43) Pub. Date: Mar. 20, 2008

(54) Integrating Voice-Enabled Local Search and Contact Lists

(75) Inventors: Francoise Beaufays, Mountain View, CA (US); Brian Strope, Palo Alto, CA (US); William J. Byrne, Davis, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/855,980

(22) Filed: Sep. 14, 2007

Related U.S. Application Data
(60) Provisional application No. 60/825,686, filed on Sep. 14, 2006.

(51) Int. Cl. G10L 11/00

(52) U.S. Cl. 704/270.1; 704/E11.001

(57) ABSTRACT

A computer-implemented method includes receiving a voice search request from a client device, identifying an entity responsive to the voice search request and contact information for the entity, and automatically adding the contact information to a contact list of a user associated with the client device.

### CROSS-REFERENCE TO RELATED APPLICATIONS

This application claims priority to U.S. Application Ser. No. 60/825,686, filed on Sep. 14, 2006, the contents of which is hereby incorporated by reference.

### TECHNICAL FIELD

This specification relates to networked searching.

### BACKGROUND

In recent years, people have demanded more and more from their computing devices. With connections to networks such as the internet, more information is available to users upon request, and users want to have access to the data and have it presented in various convenient ways.

More and more, functionality that was previously available only on fixed, desktop computers, is being made available on mobile devices such as cellular telephones, personal digital assistants, and smartphones. Such devices may store contacts and scheduling information for users, and may also provide access to the internet in manners similar to desktop computers but with more constrained displays and keyboards or keypads.

### SUMMARY

This document describes systems and techniques involving voice-activated services that combine local search with contact lists. The services can include a mechanism to automatically populate a user's contact list with voice labels corresponding to businesses that the user has reached by voice-browsing a local search service. For example, a user may initially search for a business, person, or other entity by providing a verbal search term, and the system to which the user submits the request may deliver a number of results. The user may then verbally select one of the results. With the result selected, data reflecting contact information for the result may be retrieved, the data may be stored in a contacts database associated with the user, and a verbal, or voice, tag, or label, that includes all or part of the initial request may be stored and associated with the contact information. In that manner, if the user subsequently speaks the words for the verbal tag, the system may readily recognize such a request and may immediately make contact by dialing with the saved contact information (so that follow up selection of a search result will be necessary only the first time, and such later selection may occur like normal voice dialing).

The systems and techniques described here may provide one or more advantages. For example, a user may be permitted to conduct searching verbally for particular people or businesses and may readily add information about those businesses or people into their contact lists so that the businesses or people can be quickly contacted in the future. In addition, the user may readily associate a voice label to the particular business or person. In this manner, users may more easily locate information in which they are interested, and very easily contact businesses or people associated with that information, both at the time of the initial search and later. Businesses may in turn benefit by having their contact information more readily provided to interested users, and may also more readily target promotional materials to such users based on their needs.

In one implementation, a computer-implemented method is disclosed. The method includes receiving a voice search request from a client device, identifying an entity responsive to the voice search request and identifying contact information for the entity, and automatically adding the contact information to a contact list of a user associated with the client device. The voice search request may be identified as a local search request. The entity responsive to the voice search request can comprise a commercial business. Also, the contact information can comprise a telephone number.

In some aspects, the method comprises storing a voice label in association with the contact information, where the voice label can comprise all or a portion of the received voice search request. The method may also include subsequently receiving a voice request matching the voice label and automatically making contact with the entity associated with the voice label. In addition, the method may include checking for duplicate voice labels and prompting a user to enter an alternative voice label if duplicate labels are identified. Identifying an entity responsive to the voice search request can comprise providing to a user a plurality of responses and receiving from the user a selection of one response from the plurality of responses. Also, the plurality of responses can be provided audibly in series, and the selection is receiving by a user interrupting the providing of the responses.

In other aspects, the method may additionally include automatically connecting the client device to the entity telephonically. In addition, the method may comprise presenting the contact information over a network to a user associated with the client device to permit manual editing of the contact information. Moreover, the method can include identifying a user account of a first user who is associated with the client device and a second user who is identified as an acquaintance of the first user, and providing the content information for use by the second user. In yet other embodiments, the method can also include receiving a voice label from the second user for the contact information and associating the voice label with the contact information in a database corresponding to the second user. And the method can additionally comprise transmitting the contact information from a central server to a mobile computing device.

In another implementation, a computer-implemented method is disclosed that comprises verbally submitting a search request to a central server, automatically connecting telephonically to an entity associated with the search request, and automatically receiving data representing contact information for the entity associated with the search request. The method may also comprise verbally selecting a search result from a plurality of aurally presented search results and connecting to the selected search result.

In yet another implementation, a computer-implemented system is disclosed that includes a client session server configured to prompt a user of a remote client device for input to identify one or more entities the user desires to contact, a dialer to connect the user to a selected entity, and a data channel backend sub-system connected to the client session server and a media relay to communicate contact data and digitized audio to the remote client device. The system may also include a search engine to receive search queries converted from audible input to textual form and to provide one or more responsive search results to be presented audibly to the user.

In another implementation, a computer-implemented system is disclosed. The system includes a client session server configured to prompt a user of a remote client device for input to identify one or more entities the user desires to contact, a dialer to connect the user to a selected entity, and means for providing contact information to a remote client device based on verbal selection of a contact by a user of the client device. The system may further comprise a search engine to receive search queries converted from audible input to textual form and to provide one or more responsive search results to be presented audibly to the user.

The details of one or more implementations of the identification and contact management systems and techniques are set forth in the accompanying drawings and the description below. Other features and advantages of the systems and techniques will be apparent from the description and drawings, and from the claims.

### DESCRIPTION OF DRAWINGS

FIG. 1 is an interaction diagram showing an example interaction between a user searching for a business and a voice-enabled service.

FIG. 2 is a flow chart showing actions for providing information to a user.

FIG. 3 is a schematic diagram of an example system for providing voice-enabled data access.

FIG. 4 is an interaction diagram for one system for providing voice-enabled data access.

FIG. 5 is a conceptual diagram of a system for receiving voice commands.

FIG. 6 is an example screen shot showing a display of local data from voice-based search.

FIG. 7 is a schematic diagram of exemplary general computer systems that may be used to carry out the techniques described here.

Like reference symbols in the various drawings indicate like elements.

### DETAILED DESCRIPTION

Voice-dialing is a convenient way to call people or businesses without having to remember their names: users just speak the name of the person or business they want to reach, and a speech recognition service maps their request to the desired name and/or phone number. With this type of service, users are generally limited to calling entities they have explicitly inputted into the system, e.g. by recording a voiceprint for the name, importing email contacts, and/or typing new contacts through some web interface. These systems provide a quick, reliable, interface to a small subset of the telephone network.

On the other end of the spectrum, voice-activated Local Search and Directory Assistance (DA) services provide a generic mechanism by which to access, by phone, any business or person in a country. Because of their extended scope, DA systems generally require a dialog between the user and the system before the desired name or phone number can be retrieved. For example, typical DA systems will first ask for a city and state, then whether the user desires a business, residential or governmental listing, and then the name of the business. Confirmation questions may be added. These systems have an extended coverage, but they can be too cumbersome to be used for each phone call (people don't want to spend three minutes on the phone to connect to their favorite Chinese restaurant to place a take-away order).

Described here is a particular integration of contact lists and directory assistance. The described form of integration may permit a user to select DA listings to be automatically transferred to the user's contact list, based on the user's usage.

There are two types of related technologies: voice-activated contact lists, and directory assistance systems. Voice-activated contact lists may come in two flavors. One is integrated on a communication device, as frequently offered with cellular phones. In such a case, speech recognition is typically performed on the device. Voice labels are typically entered on the device, but can be downloaded from a user-specified source. These can be typed names, or voice snippets. The other flavor of voice-dialing is implemented as a network system, and typically hosted by telephone carriers, e.g., Verizon. Users can enter their contacts through a web interface at some site, and call the site's number to then speak the name of the contact they want to be connected to. In such a case, voice recognition is typically server-based. Both approaches require the users to explicitly enter (or import) label/number pairs for the contacts they want to maintain.

The other type of related technology is directory assistance systems. This is typically hosted by telephone carriers or companies such as TelIMe or Free411 in the United States. These systems aim at making all (or almost all) phone numbers in a country available to the caller. Some of these systems are partially automated with speech recognition software, some are not. They typically rely to some degree on back-off human operators to handle difficult requests. And they typically require a few back-and-forth passages between the user and the system before the user can be connected to the desired destination (or given its number).

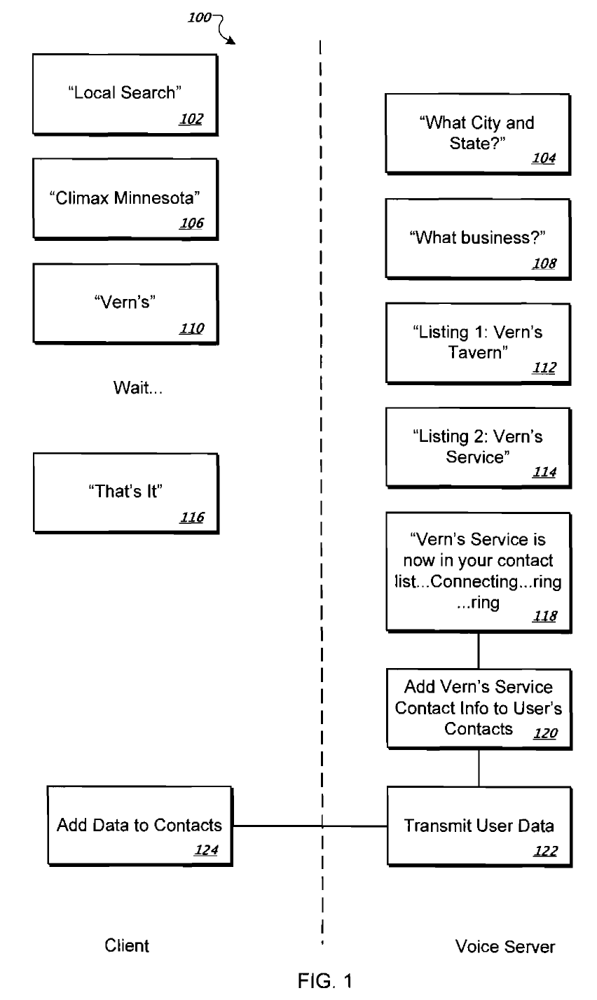

FIG. 1 is an interaction diagram showing an example interaction 100 between a user searching for a business and a voice-enabled service. Using the techniques and systems described here, a user may generally enter into an interaction that first follows a directory assistance approach, and then provides a resulting user selection to a user's contact list.

Though not shown here, the contact list may be stored on a central server, or the contact information (and in certain situations, a corresponding voice label) may be transmitted in real time or near real time to the communication device (e.g., smartphone) the user is using to access the system. Alternatively, the contact information may be stored centrally by the system, and may be updated to the user's device at a later time, such as when the user logs into an account associated with the system on the internet.

Referring to the flow shown in FIG. 1, at box 102, the user first accesses the system such as by stating a command such as “dialer” and then providing a command like “local search.” The first command indicates to the user's client device that it should access the voice-search feature of the system (e.g., on the client device), and the second command is sent to the system as an indicator of which portion of the voice features are to be accessed.

Upon receiving the “local search” command, the central system responds with “what city and state?” (box 104) to prompt the user to provide a city name followed by a state name. In this example, the user responds with “climax Minnesota” (box 106), a small town in the Northwest corner of the state. The central service may resolve the voice command using standard voice recognition techniques to produce data that matches the city and state name. The system may then prompt the user to speak the entity for which it is searching. While the entity may be a person, in this example, the system is configured to ask the user for a business name with the prompt “what business” (box 108).

The user then makes his or her best guess at the business name with “Vern's” (box 110). The system listens for the response, and upon the user pausing after saying “vern's,” the system decodes the voice command into the text “verns” and searches a database of information for matches or near matches in the relevant area, in a standard manner. In this example, the search returns at least two results, with the top two results being “Vern's Tavern” and “Vern's Service.” Using a voice-generator, the system plays the results back in series, from most relevant to least relevant.

First, at box 112, the system states “Vern's Service.” The system waits slightly after reading the first entity name to give the user a chance to select that entity. In this example, the user is silent and waits. The system then reads the next entity—“Vern's Service” (box 114). In this instance, the user quickly gives a response (which could take the form of a voice response and/or of a pressing of a key on a telephone keypad), here, in the form of saying “That's it” to confirm that the just-read result of “Vern's Service” is the “verns” that the user is seeking to contact.

Upon receiving user confirmation, the system associated with the voice server identifies contact information for Vern's Service, including by retrieving a telephone number, and begins connecting the user to Vern's Service for a voice conversation, through the standard telephone network or via a VOIP connection, for example. The voice server may simultaneously notify the user that a connection is being made, so that the user can expect to next be hearing a telephone ringing in to Vern's Service.

The voice server may also inform the user that Vern's Service has been added to the user's contact list (box 118). Thus, at the same time, a contacts management server associated with the voice server may copy contact information such as telephone and fax number, address information, and web site address from a database such as a global contacts database, into a user's personal contacts database (box 120). Alternatively, pointers to the particular business entity in the general database may be added to the user's contacts database. In addition, the sound of the user's original search request for “verns” may have initially been stored in a file such as a WMV file, and may now be accessed to attach a voice label to the entry for the entity in the user's contacts database. The file may be interpreted in various known manners to provide a fingerprint or grammar for the command so that subsequent contacts entries by the user by voice of “verns” will result in the dialing of the vern's service telephone number, without future need for the user to enter multiple commands and to disambiguate between vern's tavern and vern's service. Also, in certain implementations, the user may contact vern's service without having to enter a local search application and without having to identify a locale for the request.

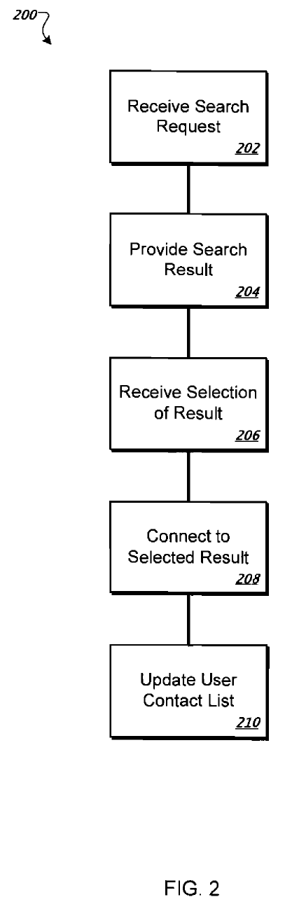

FIG. 2 is a flow chart showing actions for providing information to a user. These actions may be performed, for example, by a server or a system having a number of servers, including a voice server. In general, the illustrated process 200 involves identifying entities such as businesses in response to a user's search request, and then automatically making contact information for a selected entity available to the user (i.e., without requiring the user to enter the information or to take multiple steps to copy the information over) such as by adding the contact information for the entity to a contacts database corresponding to the user.

At box 202, the system receives a search request. The request may, in certain circumstances, be preceded by a command from the user to access a search system. Such a command may be received by an application running on the user's mobile computing device or other computing device, which may cause the application to institute a session with the system. The search request may be in the form of a verbal statement or statements. For example, the request may be received from the user over a telephone (e.g., traditional and/or VOIP) voice channel and may be interpreted at the system. The request may also be received as a file from the user's device.

In certain instances, reception of the search request may occur by an iterative process. For example, as discussed above, the user may initially identify the type of the search (e.g., local search), may then identify a locale or other parameter for the search, and may then submit the search terms—all verbally.

The system, at box 204, may then transform the request into a more traditional, textual query and generate a search result or results. For example, the system may turn each verbal request into text and then may append the various portions of the request in an appropriate manner and submit the textual request to a standard search engine. For example, if the user says “local search,” “Boston Massachusetts,” and “Franklins Pub”, the request may be transformed into the text “franklins pub, boston ma” for submission to a search engine.

The system may then present the results to the user, such as by playing, via voice synthesis techniques or similar techniques, the results in order to the user over the voice channel. Upon playing each result, the system may wait for a response from the user. If no response is received, the system may play the next result. When a response is received, the system may identify contact information for the selected entity. The contact information may include a telephone number, and the system may begin connecting the user to the entity by a voice channel (box 208). At the same time, the system may identify other contact information, and upon informing the user, may copy the contact information into a database associated with the user (box 208). In some examples, the information may be sent via a data channel to the user's device for incorporation into a contacts database on the device. Also, a grammar or other information relating to the user's original verbal request, in the form of a voice label, may be sent to the user's device also, so that the device may speed dial the contact number when the statement is spoken in the future. In this manner, a user's contact list can grow to contain all the businesses in the immediate ecosystem of the user, in a manner reminiscent of different sorts of systems like the addition of autocompletion of “to” names in applications like Google's GMail.

Various additional features may also be included with the techniques described here. For example, the weight of various entries in a user's contact list may be maintained according to how frequently they are called by the user. This way, rarely used entries fall off the list after a while. This may allows the speech recognition grammar for a user's list to stay reasonably small, thereby increasing the speech recognition accuracy of the service.

Web-based editing of the lists may also be made available to a user so that he or she can eliminate, add, or modify entries, or add nicknames for existing entries (e.g. “Little truck child development center” to “little truck”). In addition, a user may be allowed to record alternative speed dial invocating phrases if they do not like their current phrases. For example, perhaps the user initially became familiar with the “Golden Bowl” restaurant via a local search that started with “Chinese Restaurants.” The user may now prefer to dial the restaurant by saying “Golden Bowl” rather than “Chinese Restaurants.” In such a situation, the contact information page may include an icon that permits a user to voice a new shorthand for the contact. Similar edits may be made when a user wishes to replace a friend's formal name with a nickname.

A mechanism may also be put in place to prevent the same voice tag, or label, to be created twice for two different numbers (e.g. prevent the tag “starbucks” to be used for two different store locations). For example, if a “starbucks” tag is already used for a store in Mountain View, and the user calls a Starbucks store in Tahoe, the tag “starbucks in tahoe” might be used for the second store.

The user's contact list may also be auto-populated by a variety of other services such as GoogleTalk, various Google mobile services, and by people calling the user (when Brian calls Francoise, Francoise gets Brian's name inserted in her list so she can call him back). In addition, when a telephone number is acquired, additional contact information may be added to a contacts record such as by performing a reverse look-up through a data channel, such as on the internet. The reverse lookup may be performed automatically upon receipt of some initial piece of contact information (e.g., to locate more contact information), and the located information may be presented to the user to confirm that it is the information the user wants added to their database. For example, a lawyer looking for legal pundit Arthur Miller will reject information returned for contacting the playwright Arthur Miller. Similar instances can apply when telephone numbers or other contact information is ambiguous and thus returns inapplicable other contact information for the user.

Users contact lists can also be centralized and can be consolidated across user-specified ani groups. E.g., a user can group contacts gathered from his or her cellphone with contacts collected from his or her home phone, and can invite their significant other to share their cellphone contacts with the user (and vice-versa). All or some of these contacts (e.g., as selected by the user in a check-off process) can be combined into a centralized contact list that the user can call from any phone.

Some form of user authentication can also be implemented for privacy reasons. For example, before the user may access a dialer service, the user may be required to log into a central service, such as by a Google or similar login credentialing process.

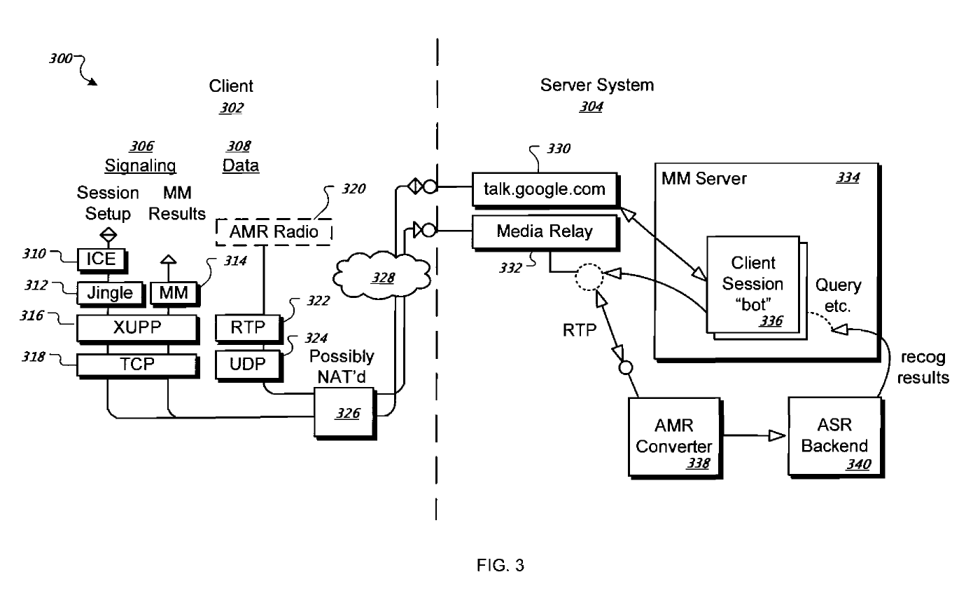

FIG. 3 is a schematic diagram of an example system 300 for providing voice-enabled data access. The illustrated system 300 is provided as one simplified example to assist in understanding the described features. Other systems are also contemplated.

The system 300 generally includes one or more clients such as client 302 and a server system 304. The client 302 may take various forms, such as a desktop computer or a portable computing device such as a personal digital assistant or smartphone. Generally the techniques discussed here may be best implemented on a mobile device, particularly when the input and output is to occur by voice. Such a system may permit a user, for example, to locate and contact businesses when their hands and eyes are busy, and then to have the businesses added to their system so that future contacts can occur much more easily.

The system client 302 generally, according to regular norms, includes a signaling component 306 and a data component 308. In this implementation, the signaling and data components 306, 308 generally use standard building blocks, with the exception of an added MM module 314. The MM module may take the form of an application or applet that communicates with a search system on an MM server 334. In particular, the module 314 may signal to the server 334 that a user is seeking to perform voice-enabled searching, and may instigate processes like those discussed in this document for identifying entities in response to a search request and providing contact information of the entities, and making telephonic contacts with the entities for the client 302.

The signaling component 306 may also include a number of standard modules that may be part of a standard internet protocol suite, including an ICE module 310, a Jingle module 312, an XMPP module, and a TCP module 318. The ICE module 310 performs actions for the Interactive Connectivity Establishment (ICE) methodology, a methodology for network address translator (NAT) traversal for offer/answer protocols. The XMPP module 316 carries out the Extensible Messaging and Presence Protocol, an open, XML-like protocol directed to near-real-time extensible instant messaging and presence information. The Jingle module 312 executes negotiation for establishing a session between devices. And the TCP module 318 executes the well-known Transmission Control Protocol.

In the data component, which may handle the passing of data such as the passing of contact data to the client 302 as discussed above, the components may generally be standard components operated in new and different manners. An AMR audio module 320, may encode and/or decode received audio via the Adaptive Multi-Rate technique. The RTP module performs the Real-Time Transport Protocol, a standardized packet format for delivering audio and video over the internet. The UDP module carries out the User Datagram Protocol, a protocol that permits internet-connected devices to send short messages (datagrams) to on another. In this manner, audio may be received and handled through a data channel.

Communications between the client 302 and the server system 304 may occur through a network such as the internet 328. In addition, data passing between the client 302 and the server system 304 may have network address translation performed (box 326) as necessary.

On the server system 304, a front end voice communication module 330 such as that used at talk.google.com, may receive voice communications from users and may provide voice (e.g., machine generated) communication from the system 304. In a similar manner, a media relay 332 may be responsible for data transfers other than typical voice communication. Audio received and/or sent through media relay 332 may be handled by an AMR converter 338 and an automatic speech recognizer (ASR) backend 340. The AMR converter 338 may perform AMR conversion and MuLaw encoding. The ASR backend may pass transformed speech (such as recognized results) to the MM server 334 for handling in manners like those discussed herein.

The MM server 334 may be a server programmed to carry out various processes like those discussed here. In particular, the MM server may instantiate client sessions 336 upon being contacted by an MM module 314, where each session may track search requests, such as requests voiced by a user, may receive results from a search engine, may provide the results audibly through module 330, and may receive selections from the results again through module 330. Upon identifying a particular entity from a result, the client sessions 336 can cause contact information to be sent to a client 302, including a voice label in the form of AMR data or in another form. The contact information may also include data such as phone numbers, person or business names, addresses, and other such data in a format that it may be automatically included in a user contacts database.

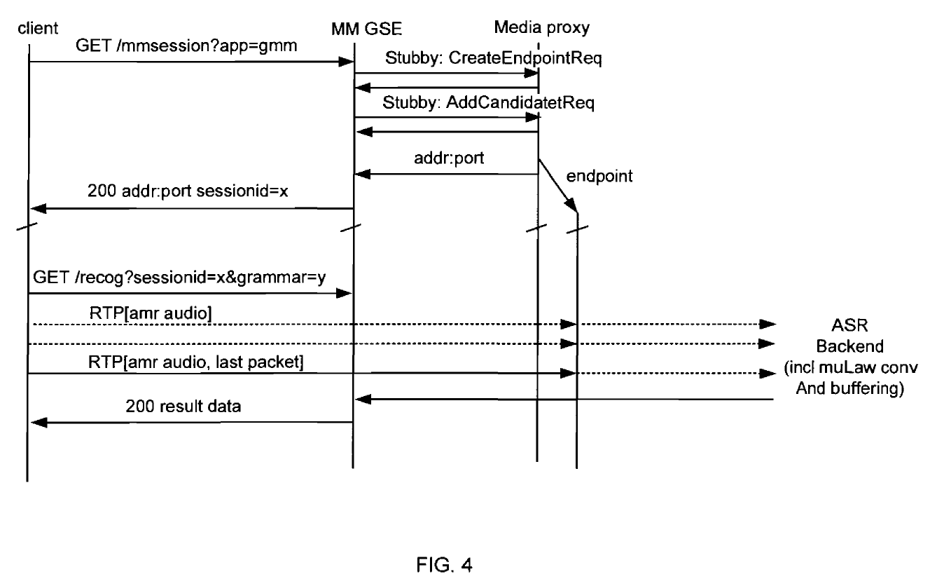

FIG. 4 is an interaction diagram for one system for providing voice-enabled data access. In general, the diagram shows interactions between a client, an MM-related server, and a media proxy. The client initially issues a GET command which causes the MM-related server to communicate with the media proxy to set up a session in a familiar fashion. A subsequent GET command from the client causes the client to be directed to communicate using RTP with the media proxy. The media proxy then forwards information to and receives information from a module like the ASR back-end 340 described above. In this manner, convenient audio information may be transmitted over a data channel.

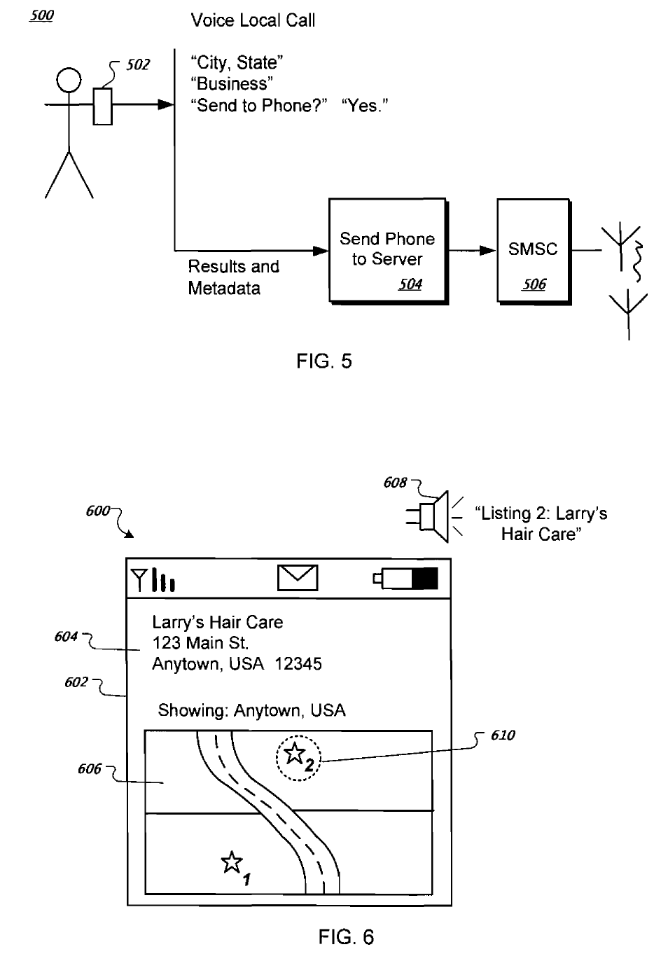

FIG. 5 is a conceptual diagram of a system 500 for receiving voice commands. In this system 500, a user of a mobile device 502 is shown communicating local search vocally into their device 502, including by an interactive process like that discussed above. Here, the user is prompted for a locale and a business name, and confirms that they would like data associated with a contact to be sent to their device 502. The data and metadata for an entity may be sent to a phone server 504, and then to a short message service center (SMSC), which is a standard mechanism for SMS messaging. In this example then, the data can be provided to the device 502 and utilized by a component such as the MM module 314 in FIG. 3.

FIG. 6 is a example screen shot showing a display 600 of local data from voice-based search. In particular, the state of the device in this example is what may take place after a user has voiced a search term and is receiving responses from a central system. A speaker 608 is shown as reading off the second search result, a stylist shop known as Larry's Hair Care.

Visual interaction may also be provided on the display 600. In this example, contact information 604 is displayed as each result is played audibly. Such information may be provided where the audible channel and the data channel may both provide information to the user immediately (or both types of information are provided by a single channel together). Such information may benefit a user in that it may permit the user to more readily determine if the name of the entity being played by the system is actually the entity the user wants (e.g., the user can look at the address to make sure it is really the entity they had in mind).

A map 606 may provide additional visual feedback, such as by showing all search results, and highlighting each result (here, result 610 is highlighted and indicated as being the second result) as it is played. Also, a number is shown next to each result, so the user may select the result by pressing the corresponding number on their telephone keypad, and be connected without having to wait for the system to read all of the results. Where a map is provided, it may also be used to assist for inputting data. In particular, if a user has a map displayed when they are providing input to a system, the system may identify the area displayed on the map (e.g., by coordinating voice and data channels) so that the user need not explicitly identify an area for a local search.

Although certain interface interactions were described above, other various interactions may also be employed as follows:

### EXAMPLE 1

### Simple Contact List Call

Action: User calls GoogleOneNumber
system>“dialer . . . ”
user>Mom and dad at home
system>“mom and dad at home, connecting” . . . ring ring

In this interaction, the user has previously identified contact information for the user's parents and associated a voice label (“mom and dad at home”) with that information. Thus, by invoking the dialer and speaking the label, the user may be connected to their parents' home.

### EXAMPLE 2.a

Action: User calls GoogleOneNumber
system>dialer . . .
user>Local Search
system>what city and state
User>Mountain View California
system>what business
user>Sue's Indian Cuisine
system>sue's indian cuisine
   i added—sue's indian cuisine—to your contact list connecting . . . ring ring
Action: System enters (sue's indian cuisine,Suels telno) in the user contact list

This interaction is similar to the interaction described above for FIG. 1. Specifically, a user identifies a business for a local search, the system finds one result in this example, and the system automatically dials the entity from the result for the user and adds the contact information for the entity to the user's contact list (either at the central system and/or on the actual user device).

### EXAMPLE 2.b

### Alternative to 2.a with a Category Search Instead of a Specific Business Search

Action: User calls GoogleOneNumber
system>dialer . . .
user>Indian restaurants
system>i found 6 listings responding to your query
listing 1: amber india restaurant on west el camino real
listing 2: shiva's indian restaurant on califomia street
listing 3: passage to india on west el camino real
listing 4: sue's indian cuisine
list . . .
user>Connect me!
system>sue's indian cuisine
i added—sue's indian cuisine—to your contact list . . . connecting . . . ring ring

Action: System enters (sue's indian cuisine,Suels telno) in the user contact list.

This example is very similar to that discussed in FIG. 1. In particular, multiple search results are generated and are played to the user in series until the user indicates a selection of one result.

### EXAMPLE 3

### Only Possible After Call 2.a or 2.b

Action: User calls GoogleOneNumber
system>dialer . . .
user>Sue's Indian Cuisine
system>sue's indian cuisine, connecting . . . ring ring

This example shows subsequent dialing by a user after information about an entity has been automatically added to the user's contact list. In particular, when the user again speaks a term relating to the entity, the entity may be contacted immediately without the need for a search. Note that under example 2b, the user spoke “Indian Restaurants” and the system is later reacted to “Sue's Indian Cuisine.” Such a result may occur, for example, by the user, in the interim, editing the voice label (which may be prompted automatically by the system whenever multiple search results are generated) or by using a voice label from a source other than the user.

As noted above, various mechanisms may be used to receive inputs from users and provide contact information to users. For illustration, four such alternatives are described next.

Alternative 1: Glue together two independent services: DA and Contact Lists. Users call a single number, choose between the contact list and DA applications, but have to go through the lengthy DA dialog each time they want to order a take-away from Sue's Indian Cuisine. This until they manually add Sue's number in their contact list.

Alternative 2: The same glue-2-services approach may offer various mechanisms to provide users with the contacts they want to add to their contact lists, e.g. sending them emails or SMS with entries to download in their list.

Alternative 3: Editable, personalized, DA system. In such a system All DA entries are available to the user as a “flat” list of contacts (just business names, and no other dialog states such as “city and state”). This may have the disadvantage of a high ambiguity (how many Starbucks in the US?, which one do I care about?), and low recognition rate (the larger the list if contacts, the more frequently misrecognitions happen).

Alternative 4: Same as 3 but multimodal, where a user speaks an entry, and browses a list of results to select one. Such an approach is still technically challenging with long result lists. It may also not be usable in eyes-free hands-free scenarios (e.g. while driving).

In another example, locating of particular search results may be a focus. Such an interaction may take the form of:
system: what city and state?
caller: palo alto califonia
system: what type of business or category?
Caller: italian restaurants
system: what specific business?
caller: il fornaio
system: search results, il fornaio on cowper street, palo alto
caller: connect me

There are four main design pieces for carrying on such an approach: (1) A user interface implementation, like the trivial realization above; (2) An automated category clustering algorithm that builds a hierarchical tree of clustered category nodes; (3) A mapping function that evaluates the tree and provides the clustering node priors given the current user cluster request; and (4) A sharding strategy for setting up the speech recognition grammar-pieces that are divided by both geography and by the automated clustering nodes, so that these pieces can be appropriately weighted at run time.

The first piece is where the user gives a system more data about how the specific business should be clustered. By asking for category information with every query, the system can fall-back to category-only searches when the specific listing request fails. The clustering stage allows the system to learn hierarchical and synonomous semantics to associate “italian food” with “italian restaurants”, and to learn that “fine dining’ may include “italian restaurants”.

The mapping function allows the system to provide node weights for each element of in the hierarchical cluster given a specific category request from the user. The sharding mechanism allows the system to quickly assemble and bias the appropriate grammar pieces that the recognizer will search, given the associated node weights. One alternative is to divide the problem only by geography. In that case, the potential confusions of the recognition task are much higher, and it is more likely that the systems will have to back off to human operators in order to achieve reasonable performance.

Another approach more commonly used by most currently planned systems is to ask for a hard decision of yellow-pages (category) vs. white-pages (business listing) before asking for search terms. This approach limits the possibility of using both types of information to improve system performance with business listings. A degenerate case of the current proposal is an initial hard-decision category question that limits the recognition grammar to specific businesses.

Such an approach will have worse accuracy than the interpolated clustering mechanism proposed here because it doesn't model well the semantic uncertainty of the category, both from the caller's intent and the uncertainty of a hard-decision categorization of any specific business.

Touch-Tone Based Data Entry with Voice Feedback

In another embodiment, a touch-tone based spelling mechanism for telephone applications may be used with systems like that described above. Using any type of touch-tone telephone (mobile or landline), users can enter letters by pressing the corresponding digit key the appropriate number of times, similar to the multi-tap functionality available on mobile devices. (For example, to enter “a”, the user presses the “2” key once, for “b” twice, etc.) However, instead of seeing the letter appear on the mobile device's screen, the user hears the letter played back over the phone's voice channel via synthesized speech or prerecorded audio.

Functionality can include the ability to add spaces, delete characters and preview what has already been entered. Such actions may occur using standard keying systems for indicating such editing functions. Thus, in terms of data flow, a user may first enter a key press. A central server may recognize which key has been pressed in various manners (e.g., DTMF tone) and may generate a voice response corresponding to the command represented by the key press. For example, if “2” is pressed once, the system may say “A”, if “2” is pressed twice, the system may say “B”. The system may also complete entries or otherwise disambiguate entries in various manners (e.g., so that multi-tap entry is not required) and may provide guesses about disambiguation audibly. For example, the user may press: “2,” “2,” “5”, and the system may speak the word “ball” or another term that is determined to have a high frequency of use on mobile devices for the entered key combination.

Automated, voice-driven directory assistance systems require callers to specify residential and business and listings or categories from a huge index. One major challenge for system quality is the recognition accuracy. Since speech recognition accuracy can never reach 100%, an alternative input mechanism is required. Without one, the system must rely on human intervention (e.g. live operators handling a portion of the calls). The spelling mechanism just described can work on all phones and can potentially eliminate the need for live operators.

Other techniques may not provide as sufficient of results. For example, predictive dialing is common today for accessing names in company directories (e.g. “Enter the first few letters of the employee's last name. For the letter ‘q’ press 7 . . . ”, etc.) This technique differs from multi-tap in that it allows the caller to press a key just once for any of the corresponding letters. For example, to select “a”, “b” or “c”, the caller would press “2” once. However, predictive dialing only works for relatively small sets (like an employee directory) and is not feasible for business or residential listings; (2) Multi-tap: Multi-tap is generally a clientside mobile device feature. The caller enters characters by pressing the corresponding digit key the appropriate number of times as described above (e.g. to enter “a”, the user presses the “2” key once, for “b” twice, etc.).

The corresponding characters are rendered graphically on the mobile device's screen. There are two drawbacks to this strategy: (a) since it is client-side, it can be hard to fold it into a server-side, telephony-based application. and (b) it does not work for traditional landline phones when it is client-side.

The techniques described above can be implemented in a VoiceXML telephony application for local search by phone. The code (both the VoiceXML and the GRXML-based grammar) may include code like that below for the following example.

DIALOG:

System: Spell the business name or category on your keypad using multitap. For example, to enter “a” press the 2 key once. To enter “b” press the 2 key twice. To enter “c” press the 2 key three times. When you're finished, press zero. To insert a space, press 1. To delete a character, press pound.

Caller: (presses “2” three times.)

System: “C”

Caller: Caller: (presses “2” once.)

System: “A”

Caller: Caller: (presses “2” twice.)

System: “B”

Caller: (presses “0”)

System: “Cab”, Got it. (does search)

VOICEXML:

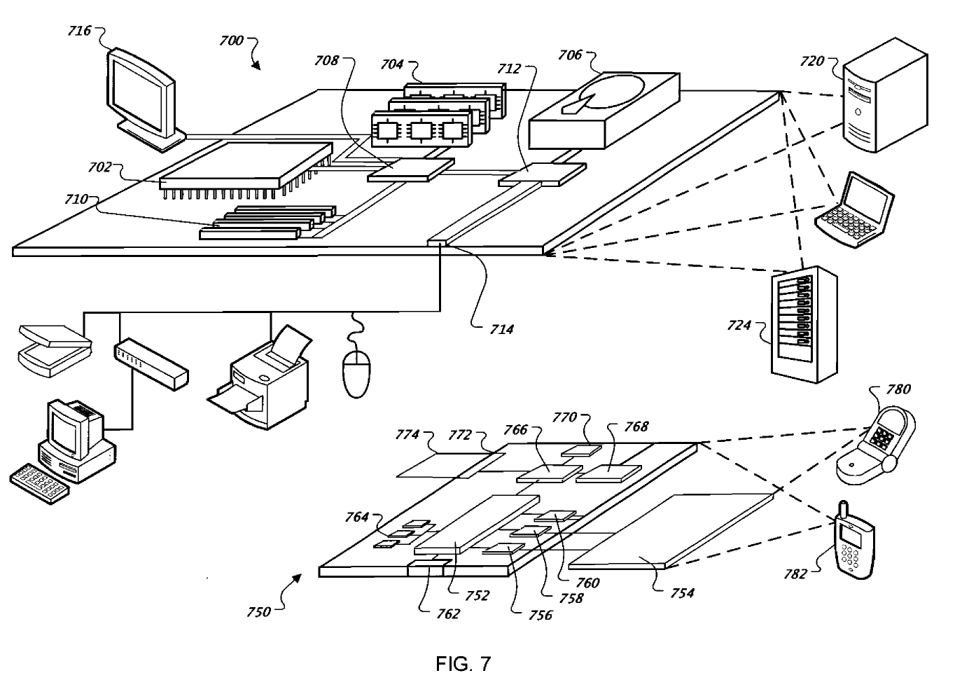

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method, comprising:
receiving a voice search request from a client device;
identifying an entity responsive to the voice search request and identifying contact information for the entity; and
automatically adding the contact information to a contact list of a user associated with the client device.

2. The method of claim 1, wherein the voice search request is identified as a local search request.

3. The method of claim 1, wherein the entity responsive to the voice search request comprises a commercial business.

4. The method of claim 1, wherein the contact information comprises a telephone number.

5. The method of claim 1, further comprising storing a voice label in association with the contact information.

6. The method of claim 5, wherein the voice label comprises all or a portion of the received voice search request.

7. The method of claim 5, further comprising subsequently receiving a voice request matching the voice label and automatically making contact with the entity associated with the voice label.

8. The method of claim 5, further comprising checking for duplicate voice labels and prompting a user to enter an alternative voice label if duplicate labels are identified.

9. The method of claim 1, wherein identifying an entity responsive to the voice search request comprises providing to a user a plurality of responses and receiving from the user a selection of one response from the plurality of responses.

10. The method of claim 8, wherein the plurality of responses is provided audibly in series, and the selection is receiving by a user interrupting the providing of the responses.

11. The method of claim 1, further comprising automatically connecting the client device to the entity telephonically.

12. The method of claim 1, further comprising presenting the contact information over a network to a user associated with the client device to permit manual editing of the contact information.

13. The method of claim 1, further comprising identifying a user account of a first user who is associated with the client device and a second user who is identified as an acquaintance of the first user, and providing the content information for use by the second user.

14. The method of claim 13, further comprising receiving a voice label from the second user for the contact information and associating the voice label with the contact information in a database corresponding to the second user.

15. The method of claim 1, further comprising transmitting the contact information from a central server to a mobile computing device.

16. a computer-implemented method, comprising:
verbally submitting a search request to a central server;
automatically connecting telephonically to an entity associated with the search request; and
automatically receiving data representing contact information for the entity associated with the search request.

17. The method of claim 16, further comprising verbally selecting a search result from a plurality of aurally presented search results and connecting to the selected search result.

18. A computer-implemented system, comprising:
a client session server configured to prompt a user of a remote client device for input to identify one or more entities the user desires to contact;
a dialer to connect the user to a selected entity; and
a data channel backend sub-system connected to the client session server and a media relay to communicate contact data and digitized audio to the remote client device.

19. The system of claim 18, further comprising a search engine to receive search queries converted from audible input to textual form and to provide one or more responsive search results to be presented audibly to the user.

20. A computer-implemented system, comprising:
a client session server configured to prompt a user of a remote client device for input to identify one or more entities the user desires to contact;
a dialer to connect the user to a selected entity; and
means for providing contact information to a remote client device based on verbal selection of a contact by a user of the client device.

21. The system of claim 20, further comprising a search engine to receive search queries converted from audible input to textual form and to provide one or more responsive search results to be presented audibly to the user.
